(19) United States
(12) Patent Application Publication
(10) Pub. No.: US 2020/0056047 A1
(43) Pub. Date: Feb. 20, 2020

(54) SILICONE ELASTOMER HAVING FLUORINATED SIDE GROUPS

(71) Applicant: WACKER CHEMIE AG, Munich (DE)

(72) Inventors: Andreas KOELLNBERGER, Kirchdorf (DE); Michael BAUER, Mehring (DE); Erich PILZWEGER, Julbach (DE)

(73) Assignee: WACKER CHEMIE AG., Munich (DE)

(21) Appl. No.: 16/497,981

(22) PCT Filed: Mar. 29, 2017
(86) PCT No.: PCT/EP2017/057455

§ 371 Date: Sep. 26, 2019

(51) Int. Cl. C08L 83/08; C08G 77/24; C08J 5/18

(52) U.S. Cl. CPC C08L 83/08; C08J 2383/08; C08J 5/18; C08G 77/24

(57) ABSTRACT

Crosslinkable silicone compositions with improved electrical properties are prepared by crosslinking an at least three component composition crosslinkable by hydrosilylation, each component containing siloxy units with 1 or 2 3,3,3-trifluoropropyl substituents.

### CROSS REFERENCE TO RELATED APPLICATIONS

This application is the U.S. National Phase of PCT Appln. No. PCT/EP2017/057455 filed Mar. 29, 2017, the disclosure of which is incorporated in its entirety by reference herein.

### BACKGROUND OF THE INVENTION

### 1. Field of the Invention

The present invention relates to low-viscosity silicone compositions which comprise α,ω-Si-vinyl copolymers, α,ω-Si—H functional copolymers and 3,3,3-trifluoropropylmethylsiloxy-containing Si—H crosslinkers, the copolymers being composed primarily of 3,3,3-trifluoropropylmethylsiloxy and dimethylsiloxy units, and also to the production of thin layers of these silicone compositions, the layers exhibiting increased electric permittivity compared to layers of standard silicones.

### 2. Description of the Related Art

EP2931792A1 discloses a process for producing silicone films and the use thereof as dielectrics, and electroactive polymers (EAPs) in actuators, sensors or generators. Particularly in the case of applications such as actuators or generators, the EAPs in the course of their lifetime will traverse several million oscillation cycles, and consequently these silicone films, on the basis of their very high fatigue resistance, their uniformity and absence of particles, constitute in principle a highly suitable dielectric for this application. The silicone compositions that are used for producing the silicone films in EP2931792A1, however, result in inadequate permittivity. This limits the sensitivity in sensors; in actuators it leads to restrictions in the operating voltage, and in generators it leads to restrictions in their effectiveness and hence in their efficiency.

It is known within the art that the dielectric properties of silicone compositions can be influenced if they are modified using polar side groups. For example, EP0927425B1 describes silicone compositions with fluorine-containing side groups—preferably trifluoropropyl groups, for use as cable sheathing in medical products. A disadvantage of the resultant polymers, which are said to have a high degree of polymerization (3500-6500), is the high viscosity, this being the reason why they have to be processed on a roll. Such silicone compositions are therefore not suitable for producing thin layers.

EP0676450B1 claims thixotropic fluorosilicone gel compositions which comprise low-viscosity, partly vinyl-terminal polymers. This means that the end groups of the vinyl polymers used, according to the examples, consist of about 40-50% of nonfunctional trimethylsilyl units, which do not participate in the crosslinking reaction. As a result, there are so-called “dangling ends”, which are an advantage in achieving a low-modulus silicone gel. For thin layers, however, the presence of loose ends is a great disadvantage, since they have an adverse effect on the resilience, i.e., the mechanical loss factor.

EP0773251B1 is concerned with the production of high-viscosity fluorinated polydiorganosiloxane compositions starting from OH-terminated polymers. With the viscosity range described here for the silicone compositions, however, it is not possible to produce thin layers.

EP0688828B1 claims solvent-resistant silicone gels based on fluorosiloxanes. Incorporated within the vinyl polymer in this case are branching sites, called T units, which pendantly carry vinyldimethylsiloxy groups, which are brought to reaction via platinum-catalyzed addition crosslinking with a Si—H crosslinker. The mechanical strength of the silicone gel disclosed in EP0688828B1, however, is much too low for production of thin layers.

EP0808876B1 utilizes a mixture of alkylhydrogensiloxane and dialkylhydrogensiloxy(perfluoroalkylethyl)siloxane in order to modify the crosslinking characteristics. Again, however, the silicone compositions described here exhibit viscosities ahead of the crosslinking reaction that are not suitable for production of thin layers.

Fluorosilicone materials have been on the market to date in the sectors of HTV/HCR (High Temperature Vulcanizing/High Consistency Rubber), LSR (Liquid Silicone Rubber) and RTV-2 (Room Temperature Vulcanizing, two-component). Silicones in the HTV sector possess a very high viscosity; the uncrosslinked constituents are firm in consistency and plastic. LSR silicones are used typically in highly automated injection molding operations. The dynamic viscosities at 25° C. and a shear rate of 1 s⁻¹ are in the range between 1,000,000 and 1,500,000 mPa·s, which is much too high for the production of thin layers. The materials are highly shear-thinning. Reference may be made, for example, to the table “Typical Properties”, on page 2 of the brochure “Silastic® Fluoro-Liquid Silicone Rubber (F-LSR)” from the “Automotive Solutions” series from Dow Corning, from 2013, with the Form No. 45-1569-01, which illustrates the connection between the high viscosities and the mechanical properties.

In the sector of the RTV silicones there are fluorosilicones on the market that are used as gels. In the case of gels whose uncrosslinked starting materials have a low dynamic viscosity, the focus is not on mechanical strengths, and hence no test values are reported. Other low-viscosity fluorosilicones with the designation “FER-7061-A/B” and “FER-7110-A/B” are described for example in the table on page 22 in the brochure “RTV Silicone Rubber for Electrical & Electronic Applications” from Shin-Etsu, from September 2016.

### SUMMARY OF THE INVENTION

An object of the invention, therefore, was to provide modified silicone compositions having a suitable low viscosity to allow the production therefrom of thin layers in a broad range from 0.1 to 500 μm which also have high uniformity in layer thickness, with these layers after curing displaying an improved permittivity and, at the same time, good or even improved mechanical properties. These and other objects are surprisingly achieved by the silicone compositions of the invention, wherein it has surprisingly been found that a combination of α,ω-Si-vinyl copolymers, α,ω-Si—H functional copolymers and 3,3,3-trifluorpropylmethylsiloxy containing Si—H comb crosslinkers having at least 3 Si—H functions per molecule, unites the advantages of low initial polymer viscosity with good mechanical properties of the crosslinked elastomer product, the copolymers being composed primarily of 3,3,3-trifluoropropylmethylsiloxy and dimethylsiloxy units. Moreover, because of the low initial viscosities, it is possible to produce thin layers by means of standard technologies such as knife coating, nozzle coating or roller coating. Furthermore, the material can also be used for 3D printing.

It has likewise surprisingly been found that the silicone compositions of the invention are soluble in organic solvents and low molecular mass polydimethylsiloxanes provided the 3,3,3-trifluoropropylmethylsiloxy units content does not exceed 40 mol %.

### DETAILED DESCRIPTION OF THE PREFERRED EMBODIMENTS

A subject of the present invention, therefore, are curable silicone compositions, comprising

(A) 20-70 wt % of at least one polyorganosiloxane having a dynamic viscosity of 50-100,000 mPa·s (at 25° C. and a shear rate d=1 s⁻¹) and having at least two radicals per molecule with aliphatic carbon-carbon multiple bonds, and further comprising at least 5 mol % of 3,3,3-trifluoropropylmethylsiloxy or at least 5 mol % of bis(3,3,3-trifluoropropyl)siloxy units or at least 5 mol % of a mixture of both of these,

(B) 10-70 wt % of at least one linear α,ω-Si—H functional polyorganosiloxane having a dynamic viscosity of 50-100,000 mPa·s (at 25° C. and a shear rate d=1 s⁻¹), and further comprising at least 5 mol % of 3,3,3-trifluoropropylmethylsiloxy or at least 5 mol % of bis(3,3,3-trifluoropropyl)siloxy units or at least 5 mol % of a mixture of both of these,

(C) 0.1-50 wt % of at least one organosilicon compound containing at least 3 hydrogen atoms bonded to silicon per molecule, and further comprising at least 2.5 mol % of 3,3,3-trifluoropropylmethylsiloxy or at least 2.5 mol % of bis(3,3,3-trifluoropropyl)siloxy units or at least 2.5 mol % of a mixture of both of these,

(D) 1-40 wt % of reinforcing filler having a specific BET surface area of at least 50 m²/g, and

(E) at least one hydrosilylation catalyst, the amounts always being selected so that they amount in total to 100 wt %.

### Component (A)

The composition of the polyorganosiloxane (A) corresponds preferably to the average general formula (1)

R¹ₓR²_{y}SiO_{(4-x-y)/2} (1)

in which

R¹ independently at each occurrence denotes monovalent, optionally halogen- or cyano-substituted C₁-C₁₀ hydrocarbon radicals which are optionally bonded via an organic divalent group to silicon and which contain aliphatic carbon-carbon multiple bonds,

R² independently at each occurrence denotes monovalent, optionally halogen- or cyano-substituted C₁-C₁₀ hydrocarbon radicals which are SiC-bonded and are free from aliphatic carbon-carbon multiple bonds, with the proviso that as R² at least 5 mol % of 3,3,3-trifluoropropylmethylsiloxy or at least 5 mol % of bis(3,3,3-trifluoropropyl)siloxy units or at least 5 mol % of a mixture of both of the latter are present in the polyorganosiloxane (A),

x is a nonnegative number with the proviso that there are at least two radicals R¹ in each molecule, and

y is a nonnegative number with the proviso that the sum (x+y) is less than or equal to 3, more preferably in the range from 1.8 to 2.5.

The alkylene group R¹ may comprise any desired groups amenable to an addition reaction (hydrosilylation) with an SiH-functional compound. If radical R¹ comprises SiC-bonded, substituted hydrocarbon radicals, preferred substituents are halogen atoms, cyano radicals and —OR³. R³ in this context, independently at each occurrence, is identical or different and denotes a hydrogen atom or a monovalent hydrocarbon radical having 1 to 20 carbon atoms.

Preferably R¹ comprises alkenyl and alkynyl groups having 2 to 16 carbon atoms such as vinyl, allyl, methallyl, 1-propenyl, 5-hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl and styryl radicals, with vinyl, allyl and hexenyl radicals being used with particular preference. The preferred radicals R² may be bonded in any position of the polymer chain, more particularly to the terminal silicon atoms.

Examples of R² are the monovalent radicals —F, —Cl, —Br, OR³, —CN, —SCN, —NCO and SiC-bonded, substituted or unsubstituted hydrocarbon radicals, which may be interrupted by oxygen atoms or by the group —C(O)—, and also divalent radicals Si-bonded on both sides. If radical R² comprises SiC-bonded, substituted hydrocarbon radicals, preferred substituents are halogen atoms, phosphorus-containing radicals, cyano radicals, —OR³, —NR³—, —NR³₂, —NR³—C(O)—NR³₂, —C(O)—NR³₂, —C(O)R³, —C(O)OR³, —SO₂-Ph and —C₆F₅; R³ here corresponds to the definition indicated for it above, and Ph denotes the phenyl radical.

Further examples of radicals R² are alkyl radicals such as the methyl, ethyl, n-propyl, isopropyl, n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical; cycloalkyl radicals such as cyclopentyl, cyclohexyl, cycloheptyl and methylcyclohexyl radicals; aryl radicals such as the phenyl, naphthyl, anthryl and phenanthryl radical, alkaryl radicals such as o-, m-, and p-tolyl radicals, xylyl radicals and ethylphenyl radicals; and aralkyl radicals such as the benzyl radical, the α- and the B phenylethyl radicals.

Examples of substituted radicals R² are haloalkyl radicals such as the 3,3,3-trifluoro-n-propyl radical, the 2,2,2,2′,2′,2′-hexafluoroisopropyl radical, the heptafluoroisopropyl radical, haloaryl radicals such as the o-, m- and p-chlorophenyl radical, —(CH₂)—N(R³)C(O)NR³₂, —(CH₂)ₙ—C(O)NR³, —(CH₂)ₒ—C(O)R³, —(CH₂)ₒ—C(O)OR³, —(CH₂)ₒ—C(O)NR³₂, —(CH₂)—C(O)—(CH₂)ₚC(O)CH₃, —(CH₂)—O—CO—R³, —(CH₂)—NR³—(CH₂)ₚ—NR³₂, —(CH₂)ₒ—O—(CH₂)ₚCH(OH)CH₂OH, —(CH₂)ₒ(OCH₂CH₂)ₚOR³, —(CH₂)ₒ—SO₂-Ph and —(CH₂)ₒ—O—C₆F₅, where R³ corresponds to the definition indicated for it above, Ph denotes the phenyl radical, and o and p denote identical or different integers between 0 and 10.

Examples of R² as divalent radicals Si-bonded on both sides are those which derive from the monovalent examples stated above for radical R² by means of an additional bonding through substitution of a hydrogen atom; examples of such radicals are —(CH₂)—, —CH(CH₃)—, —C(CH₃)₂—, —CH(CH₃)—CH₂—, —C₆H₄—, —CH(Ph)-CH₂—, —C(CF₃)₂—, —(CH₂)ₒ—C₆H₄—(CH₂)ₒ—, —(CH₂)ₒ—C₆H₄—C₆H₄—(CH₂)ₒ—, —(CH₂O)ₚ, (CH₂CH₂O)ₒ, —(CH₂)ₒ—O_{z}—C₆H₄—SO₂—C₆H₄—O_{z}—(CH₂)ₒ—, where z is 0 or 1, and Ph, o and p have the definition stated above.

Radical R² is preferably a monovalent, SiC-bonded, optionally substituted hydrocarbon radical having 1 to 18 carbon atoms and being free from aliphatic carbon-carbon multiple bonds, and more preferably is a monovalent, SiC-bonded hydrocarbon radical having 1 to 6 carbon atoms and being free from aliphatic carbon-carbon multiple bonds, and more particularly is the methyl or 3,3,3-trifluoro-n-propyl radical.

The molecular weight of the constituent (A) may vary within wide limits, for instance between 10² and 10⁵ g/mol. Hence, for example, the constituent (A) may be a relatively low molecular mass, alkenyl-functional oligosiloxane, such as 1,2-divinyl-3,3,3-trifluoropropyltrimethyldisiloxane, but may also be a high-polymer polydimethylsiloxane possessing in-chain or terminal Si-bonded vinyl groups, with a molecular weight, for example, of 10⁵ g/mol (number average determined by NMR). The structure of the molecules forming the constituent (A) is not fixed either; in particular, the structure of a siloxane of relatively high molecular mass, in other words oligomeric or polymeric, may be linear, cyclic, branched or else resinlike, networklike. Linear and cyclic polysiloxanes are composed preferably of units of the formula R²₃SiO_{1/2}, R¹R²₂SiO_{1/2}, R¹R²SiO_{1/2} and R²₂SiO_{2/2}, where R² and R¹ have the definition indicated above. Branched and networklike polysiloxanes additionally comprise trifunctional and/or tetrafunctional units, preferably those of the formulae R²SiO_{3/2}, R¹SiO_{3/2} and SiO_{4/2}, where R² and R¹ have the definition indicated above.

Also possible, of course, is the use of mixtures of different siloxanes satisfying the criteria of constituent (A).

The component (A) preferably has dynamic viscosities of at least 50 mPa·s, preferably 500 to 20,000 mPa·s, in each case at 25° C. and a shear rate of d=1 s⁻¹. Particularly preferred as component (A) is the use of vinyl-functional, substantially linear polydiorganosiloxanes having a dynamic viscosity of 50 to 100,000 mPa·s, more preferably of 500 to 20,000 mPa·s, in each case at 25° C. and a shear rate of d=1 s⁻¹.

(A) is used in amounts of 20-70 wt %, preferably 25-65 wt % and more preferably 30-60 wt %.

### Component (B)

Component (B) used is a linear polyorganosiloxane which contains Si-bonded hydrogen atoms and which is capable of chain-extending activity. This property is typically achieved by (B) being an α,ω-Si—H functional polydimethylsiloxane of the general formula (2)

R²_{c}H_{d}SiO_{(4-c-d)/2} (2)

where

R² has the definition indicated above,

c is between 1 and 3 and

d is between 0.001 and 2,

with the proviso that the sum of c+d is less than or equal to 3 and there are at most two Si bonded hydrogen atoms per molecule.

The organopolysiloxane (B) used in accordance with the invention preferably contains Si-bonded hydrogen in the range from 0.001 to 1.7 weight percent, based on the total weight of the organopolysiloxane (B).

The molecular weight of the constituent (B) may likewise vary within wide limits, for instance between 10² and 10⁵ g/mol. Hence the constituent (B) may be, for example, a relatively low molecular mass, SiH-functional oligosiloxane, such as 1,1,3-trimethyl-3-(3,3,3-trifluoropropyl)disiloxane, for example, but may also be a linear oligomeric or polymeric or high-polymeric polydimethylsiloxane possessing terminal SiH groups.

Linear constituents (B) are preferably composed of units of the formula R²₃SiO_{1/2}, HR²₂SiO_{1/2}, HR²SiO_{2/2} and R²₂SiO_{2/2}, where R² has the definition indicated above.

Of course, mixtures of different siloxanes satisfying the criteria of constituent (B) may also be used. Particularly preferred is the use of low molecular mass SiH-functional compounds such as tetrakis(dimethylsiloxy)silane and tetramethylcyclotetrasiloxane, and also of SiH-containing siloxanes of higher molecular mass, such as poly(hydrogenmethyl)siloxane and poly(dimethylhydrogenmethyl)siloxane with a viscosity at 25° C. of 10 to 100,000 mPa·s at a shear rate of d=1 s⁻¹, with at least 5 mol % of the chain units containing at least one 3,3,3-trifluoropropyl group. A particularly preferred viscosity range is that from 10 to 20,000 mPa·s (25° C., d=1 s⁻¹).

The amount of constituent (B) in the crosslinkable silicone compositions of the invention is preferably such that the molar ratio of SiH groups from component (B) to aliphatically unsaturated groups from (A) is 0.1 to 1, more preferably between 0.3 and 0.9.

(B) is used in amounts of 10-70 wt %, preferably 20 to 50 wt %.

### Component (C)

Employed as component (C) are organosilicon compounds which have at least 3 Si-bonded hydrogen atoms. Preference is given to using linear, cyclic or branched organopolysiloxanes composed of units of the general formula (3)

R²ₑH_{f}SiO_{(4-e-f)/2} (3)

where

R² has the definition indicated above, with the difference that as R² at least 2.5 mol % of 3,3,3-trifluoropropylmethylsiloxy or at least 2.5 mol % of bis(3,3,3-trifluoropropyl)siloxy units or at least 2.5 mol % of a mixture of both are present in component (C),

e is between 0 and 3 and

f is between 0 and 2,

with the proviso that the sum of e+f is less than or equal to 3 and there are at least three Si bonded hydrogen atoms per molecule.

The organopolysiloxane (C) used in accordance with the invention preferably contains Si-bonded hydrogen in the range from 0.04 to 1.7 percent by weight, based on the total weight of the organopolysiloxane (C).

The molecular weight of constituent (C) may likewise vary within wide limits, for instance between 10² and 10⁵ g/mol. Hence the constituent (C) may be, for example, a relatively low molecular mass, SiH-functional oligosiloxane, 1,1,5,5-tetramethyl-3-(3,3,3-trifluoropropyl)trisiloxane, but may also be a high-polymer polydimethylsiloxane possessing in-chain and optionally terminal SiH groups, or a silicone resin comprising SiH groups.

The structure of the molecules forming the constituent (C) is not fixed either; in particular, the structure of a siloxane of relatively high molecular mass, in other words oligomeric or polymeric SiH-containing siloxane, may be linear, cyclic, branched or else resinlike, networklike. Linear and cyclic polysiloxanes (C) are composed preferably of units of the formula R²₃SiO_{1/2}, HR²₂SiO_{1/2}, HR²SiO_{1/2} and R²₂SiO_{2/2}, where R² has the definition indicated above. Branched and networklike polysiloxanes additionally comprise trifunctional and/or tetrafunctional units, preferably those of the formulae R²SiO_{3/2}, HSiO_{3/2} and SiO_{4/2}, where R² has the definition indicated above.

Also possible, of course, is the use of mixtures of different siloxanes satisfying the criteria of constituent (C).

Particularly preferred is the use of low molecular mass SiH-functional compounds such as tetrakis(dimethylsiloxy)silane and tetramethylcyclotetrasiloxane, and also of SiH-containing siloxanes of higher molecular mass, such as poly(hydrogen-methyl)siloxane and poly(dimethylhydrogenmethyl)siloxane having a viscosity at 25° C. of 10 to 20,000 mPa·s at a shear rate of d=1 s⁻¹, with at least 2.5 mol % of the chain units containing at least one 3,3,3-trifluoropropyl group. Particularly preferred is the viscosity range from 50 to 1000 mPa·s (25° C., d=1 s⁻¹).

The amount of constituent (C) in the crosslinkable silicone compositions of the invention is preferably such that the molar ratio of SiH groups (sum total of SiH from component (B) and component (C)) to aliphatically unsaturated groups from (A) is 0.5 to 20, preferably between 0.6 and 5.0 and more preferably between 0.8 and 2.5.

(C) is preferably used in amounts of 0.1-50 wt %, more preferably between 0.5 and 30 wt %, more preferably between 1 and 10 wt %.

In the course of the reaction of (A) with (B) and (C), preferentially either 3,3,3-trifluoropropylmethylsiloxy units or bis(3,3,3-trifluoropropyl)siloxy units are incorporated in the PDMS. The distribution here may be statistical, or in the form of blocks (block copolymers). The fraction of the 3,3,3-trifluoropropyl groups in mol % is responsible for the desired effects of the compositions of the invention. The increase in the electric permittivity in comparison to PDMS is not linear, and so preferably a maximum fraction of 50 mol % is sufficient in order to achieve the desired effect. The 3,3,3-trifluoropropylmethylsiloxy groups or bis(3,3,3-trifluoropropyl)siloxy groups content of the polymers used is at least 5 mol % in the case of (A) and (B) and at least 2.5 mol % in the case of (C), preferably in each case between 10 mol % and 80 mol % and more preferably between 20 mol % and 50 mol %.

The electric permittivity measured at 50 Hz rises with the modification from about 2.8 for PDMS to 6.0 for a 40 mol % formulation of the polymers. Higher degrees of modification allow the permittivity to climb to approximately 7.0.

The components (A), (B) and (C) that are used in accordance with the invention are commercial products known to the skilled person and/or can be produced by said skilled person by methods which are commonplace in chemistry.

Component (D)

Component (D) represents the group of the reinforcing fillers which have also been used to date for producing addition-crosslinkable compositions. Examples of reinforcing fillers which can be used as a component in the silicone compositions of the invention are fumed or precipitated silicas having BET surface areas of at least 50 m²/g and also carbon blacks and activated carbons such as furnace black and acetylene black, preference being given to fumed and precipitated silicas having BET surface areas of at least 50 m²/g and at most 300 m²/g. Particularly preferred BET surface areas are those between 75 and 200 m²/g. The stated silica fillers may be hydrophilic in nature or may have been hydrophobized by known methods. The amount of actively reinforcing filler in the crosslinkable composition of the invention is in the range from 1 to 40 wt %, preferably 5 to 35 wt %, and more preferably between 10 to 30 wt %.

With particular preference the crosslinkable silicone compositions are characterized in that the filler (D) is surface-treated. The surface treatment is achieved by methods known in the prior art for hydrophobizing finely divided fillers. The hydrophobization may take place, for example, either before the incorporation into the polyorganosiloxane or else in the presence of a polyorganosiloxane, by the in situ method. Both methods may be carried out either as a batch operation or continuously. Hydrophobizing agents whose use is preferred are organosilicon compounds which are able to react with the filler surface with formation of covalent bonds, or which are durably physisorbed on the filler surface. Examples of hydrophobizing agents are alkylchlorosilanes, such as methyltrichlorosilane, dimethyldichlorosilane, trimethylchlorosilane, octyltrichlorosilane, octadecyltrichlorosilane, octylmethyldichlorosilane, octadecylmethyldichlorosilane, octyldimethylchlorosilane, octadecyldimethylchlorosilane and tert-butyldimethylchlorosilane; alkylalkoxysilanes, such as dimethyldimethoxysilane, dimethyldiethoxysilane, trimethylmethoxysilane and trimethylethoxysilane; trimethylsilanol; cyclic diorgano(poly)siloxanes, such as octamethylcyclotetrasiloxane, decamethylcyclopentasiloxane; linear diorganopolysiloxanes, such as dimethylpolysiloxanes having trimethylsiloxy end groups and also dimethylpolysiloxanes having silanol or alkoxy end groups; disilazanes, such as hexaalkyldisilazanes, especially hexamethyldisilazane, divinyltetramethyldisilazane, bis(trifluoropropyl)tetramethyldisilazane; cyclic dimethylsilazanes, such as hexamethylcyclotrisilazane. Mixtures of the hydrophobizing agents stated earlier on above may also be used. To accelerate the hydrophobization, the addition of catalytically active additives is optionally also made, such as amines, metal hydroxides and water, for example.

The hydrophobization may take place, for example, in one step, using one or a mixture of two or more hydrophobizing agent(s), or else using one or more hydrophobizing agents in a plurality of steps.

As a consequence of a surface treatment, preferred fillers (D) have a carbon content of at least 0.01 to at most 20 wt %, preferably between 0.1 and 10 wt %, more preferably between 0.5 to 5 wt %. Particularly preferred are hydrophobized fillers (D) wherein the functional groups which are anchored on the surface by the hydrophobization are unable to participate in the hydrosilylation reaction. Likewise preferred are those crosslinkable silicone compositions characterized in that the filler (D) is a surface-treated silica having 0.01 to 2 wt % of Si-bonded, aliphatically unsaturated groups. These are, for example, Si-bonded vinyl groups. In the silicone composition of the invention, the constituent (D) is used preferably as individual or likewise preferably as a mixture of two or more finely divided fillers.

Component (E)

Component (E) represents a hydrosilylation catalyst. Catalysts used as component (E) can be all of those known in the prior art. Component (E) may be a platinum group metal, as for example platinum, rhodium, ruthenium, palladium, osmium or iridium, an organometallic compound, or a combination thereof. Examples of component (E) are compounds such as hexachloroplatinic (IV) acid, platinum dichloride, platinum acetylacetonate and complexes of said compounds encapsulated in a matrix or in a core/shell-like structure. The low molecular weight platinum complexes of the organopolysiloxanes include 1,3-diethenyl-1,1,3,3-tetramethyldisiloxane complexes with platinum. Further examples are platinum phosphite complexes, platinum-phosphine complexes or alkyl platinum complexes. These compounds may be encapsulated within a resin matrix.

The concentration of component (E), for catalyzing the hydrosilylation reaction of components (A) and (B) and (C) on exposure, is sufficient to generate the heat required here in the process described. The amount of component (E) may be between 0.1 and 1000 parts per million (ppm), 0.5 and 100 ppm or 1 and 25 ppm of the platinum group metal, depending on the total weight of the components. The cure rate may be low if the constituent of the platinum group metal is present at below 1 ppm. The use of more than 100 ppm of the platinum group metal is uneconomical or may reduce the stability of the silicone composition.

Component (F)

The silicone compositions of the invention may optionally comprise all further adjuvants (F) which have also been used to date in the production of addition-crosslinkable compositions. The silicone composition of the invention may selectively comprise, as constituents, further additives in a proportion of up to 70 wt %, preferably 0 to 40 wt %. These additives may be, for example, inert fillers, resinous polyorganosiloxanes different from the siloxanes (A), (B) and (C), nonreinforcing fillers, fungicides, fragrances, rheological additives, inhibitors such as corrosion inhibitors or oxidation inhibitors, light stabilizers, flame retardants and agents for influencing the electrical properties, dispersing assistants, solvents, adhesion promoters, pigments, dyes, plasticizers, organic polymers, stabilizers, such as heat stabilizers, etc. They include additions such as quartz flour, diatomaceous earth, clays, chalk, lithopone, carbon blacks, graphite, metal oxides, metal carbonates, metal sulfates, metal salts of carboxylic acids, metal dusts, fibers, such as glass fibers, polymeric fibers, plastics powders, etc.

These nonreinforcing fillers may, moreover, be heat-conducting or electrically conducting. Examples of heat-conducting fillers are aluminum nitride; aluminum oxide; barium titanate; beryllium oxide; boron nitride; diamond; graphite; magnesium oxide; particulate metal such as, for example, copper, gold, nickel or silver; silicon carbide, tungsten carbide; zinc oxide, and combinations thereof. Heat-conducting fillers are known in the prior art and are available commercially. For example, CB-A20S and A1-43-Me are aluminum oxide fillers in various particle sizes that are available commercially from Showa-Denko KK, Japan, and AA-04, AA-2 and AAl 8 are aluminum oxide fillers which are available commercially from Sumitomo Chemical Company. Silver fillers are available commercially from Metalor Technologies U.S.A. Corp. of Attleboro, Mass., U.S.A. Boron nitride fillers are available commercially from Advanced Ceramics Corporation, Cleveland, Ohio, U.S.A.

If the optional solvents (F) are used, care should be taken to ensure that the solvent has no deleterious effects on the overall system. Suitable solvents (F) are known in the prior art and are available commercially. The solvent, for example, may be an organic solvent having 3 to 20 carbon atoms. The examples of solvents include aliphatic hydrocarbons such as, for example, nonane, decalin and dodecane; aromatic hydrocarbons such as, for example, mesitylene, xylene and toluene; esters such as, for example, ethyl acetate and butyrolactone; ethers such as, for example, n-butyl ethers and polyethylene glycol monomethyl ether; ketones such as, for example, methyl isobutyl ketone and methyl pentyl ketone; silicone fluid such as, for example, linear, branched and cyclic polydimethylsiloxanes differing from (A), (B) and (C), and combinations of these solvents. The optimum concentration of a particular solvent in a formulation may be determined easily by routine tests. Depending on the weight of the compound, the amount of the solvent (F) may be between 0 and 95% or between 1 and 95%.

Another key advantage of the compositions of the invention is that in spite of the presence of substantial proportions of 3,3,3-trifluoropropyl groups, they still always have a certain solubility in solvents (F).

Inhibitors and stabilizers suitable as (F) serve for targeted adjustment of the processing life, onset temperature and crosslinking rate of the silicone compositions of the invention. These inhibitors and stabilizers are very well known in the field of addition-crosslinking compositions. Examples of customary inhibitors are acetylenic alcohols, such as 1-ethynyl-1-cyclohexanol, 2-methyl-3-butyn-2-ol and 3,5-dimethyl-1-hexyn-3-ol, 3-methyl-1-dodecyn-3-ol, polymethylvinylcyclosiloxanes such as 1,3,5,7-tetravinyltetramethyltetracyclosiloxane, low molecular mass silicone oils with methylvinyl-SiO_{1/2} groups and/or R₂vinylSiO_{1/2} end groups, such as divinyltetramethydisiloxane, tetravinyldimethyldisiloxane, trialkyl cyanurates, alkyl maleates, such as diallyl maleates, dimethyl maleate and diethyl maleate, alkyl fumarates, such as diallyl fumarate and diethyl fumarate, organic hydroperoxides such as cumene hydroperoxide, tert-butyl hydroperoxide and pinane hydroperoxide, organic peroxides, organic sulfoxides, organic amines, diamines and amides, phosphanes and phosphites, nitriles, triazoles, diaziridines and oximes. The effect of these inhibitor additions (F) is dependent on their chemical structure, and so the concentration has to be determined individually. Inhibitors and inhibitor mixtures are added preferably in a proportion of 0.00001% to 5%, based on the total weight of the mixture, more preferably 0.00005 to 2% and very preferably 0.0001 to 1%.

A further subject of the present invention is the production of the silicone composition of the invention. The compositions of the invention may be one-component silicone compositions and also two-component silicone compositions. In the latter case, the two components of the compositions of the invention may comprise all constituents in any combination, generally with the proviso that one component does not simultaneously comprise siloxanes with aliphatic multiple bond, siloxanes with Si-bonded hydrogen and catalyst, in other words essentially not simultaneously all of the constituents (A), (B), (C) and (D).

The compounds (A) and (B) and (C) used in the compositions of the invention are selected, as is known, such that crosslinking is possible. Thus, for example, compound (A) has at least two aliphatically unsaturated radicals, (B) two Si-bonded hydrogens, and (C) at least three Si-bonded hydrogen atoms.

The mixing or compounding of the constituents takes place according to the methods as they have been known to date in the prior art. The sequence of the ingredients here is immaterial. The compounding operation may take from a few minutes up to several hours. The introduction of shearing energy promotes the process of compounded incorporation of the reinforcing filler. The temperature during mixing is customarily between 0 and 200° C., more preferably between 25 and 150° C.

After all of the constituents have been mixed, the dynamic viscosity of the silicone composition, at 25° C. and a shear rate of 1 s⁻¹, is between 100 mPa·s and 1000 Pa·s, preferably between 500 mPa·s and 100 Pa·s and more preferably between 1000 mPa·s and 50 Pa·s.

The crosslinkable silicone compositions of the invention have the advantage that they can be produced in a simple process using readily available starting materials and hence economically. The crosslinkable compositions of the invention have the further advantage that as a one-component formulation they have good storage stability at 25° C. and ambient pressure, and crosslink rapidly only at elevated temperature. The silicone compositions of the invention have the advantage that in the case of two-component formulation, after mixing of the two components, they produce a crosslinkable silicone material whose processing properties are maintained, depending on the inhibitor added and the amount thereof, over a long period at 25° C. and ambient pressure, thus exhibiting a long pot life, and undergo rapid crosslinking only at elevated temperature.

A further advantage of the silicone compositions of the invention is the good mechanical performance in spite of low viscosity of the starting materials, this being achieved by virtue of the simultaneous presence of the components (B) and (C).

Where the silicone compositions of the invention or the thin films which can be produced from them are used as a dielectric in, for example, sensors, actuators or generators which operate on the principle of dielectric electroactive polymers, they offer the advantage of a greater electric permittivity. In the sensor sector, the advantage lies in an increased sensitivity, in the actuator sector in a lower operating voltage, and in the generator sector in a greater efficiency of the components. Comparing the dielectric properties with other silicone elastomers known from the prior art and modified with polar side groups, moreover, the advantage of the compositions of the invention lies in a low electrical loss angle. Another advantage of the compositions of the invention is that the hardness range can be selected between about 1 and 50 Shore A, so leading to low, adjustable moduli of elasticity.

An advantage of the compositions of the invention, moreover, is that by virtue of the low viscosity in conjunction with mechanical properties which are good for the viscosity range, it is possible to produce thin layers or films in the range about between 5 and 500 μm. The desired profile of properties can be achieved only through the so-called chain extension from the combination of (A), (B) and (C), meaning that Si-vinyl copolymers (A), α,ω-Si—H functional copolymers (B) and Si—H crosslinkers (C) must be present that are able to react in situ to give long chains having relatively few nodal points, hence allowing the achievement of good mechanical properties in the crosslinked silicone elastomers.

A further advantage of the compositions of the invention is the possibility of being able to use them to produce thin layers by means of various operations such as, for example, coating processes (knife coating, slot die coating, roller coating, etc.). The thin layers are situated preferably in the range below 500 μm and more preferably in the range below 250 μm, more particularly below 200 μm. A preferred process for producing thin layers is that of slot die coating.

Besides the absolute layer thickness, a critical role is played by the uniformity of the layer thickness over the entire produced web in the case of those applications where the film is used, for example, as a dielectric or as a membrane.

A further subject of the present invention is therefore the use of the silicone composition of the invention for producing thin silicone films having a film thickness of 0.1 to 500 μm.

The breakdown voltage of the silicone film produced is at least 30 kV/mm. The silicone film can be used in actuators, sensors or generators.

One possible process for the slot die process is the continuous process for producing thin silicone films having a film thickness of 0.1 to 500 μm and a thickness accuracy of ±5% measured over an area of 200 cm²,

characterized in that

i) the solvent-containing or solvent-free silicone composition of the invention is applied through the slot of a slot die to a moving support,

ii) subsequently the solvent, if present, is removed from the silicone layer which forms on the support film, and the silicone layer is crosslinked,

iii) the resulting silicone film can be separated from the support after the crosslinking,

with the following provisos:
the slot die in step i) is at an angle of between 10° and 90° (preferably 90°, more particularly vertically from above) to the support;
the running speed of the support is between 0.1 and 500 m/min;
the dynamic viscosity as measured to DIN53019 (at 25° C. and a shear rate of 1 s⁻¹) of the silicone composition of the invention is between 100 mPa·s and 1000 Pa·s.

The silicone film thus produced can be employed, for example, in multi-ply assemblies, these assemblies comprising at least one ply of the silicone film. Multi-ply assemblies can be used as dielectric, electroactive polymers (EAPs) in actuators, sensors or generators.

It has emerged, moreover, that the silicone compositions of the invention are also suitable for producing media-resistant components such as seals by means of molding processes (injection molding, rapid prototyping, etc.), since they are resistant, for example, toward nonpolar solvents.

A further subject of the present invention is therefore the use of the silicone composition of the invention for producing media-resistant components.

It is found, moreover, that the silicone composition of the invention is also suitable for producing shaped articles in 3D printing, preferably by the generative drop-on-demand (DOD) process.

A further subject of the present invention is therefore the use of the silicone composition of the invention for producing shaped articles in 3D printing by the generative drop-on-demand (DOD) process.

### Viscosity Determination

The viscosities in the present invention are dynamic viscosities η and were measured on an Anton Paar MCR 302 rheometer in accordance with DIN EN ISO 3219: 1994 and DIN 53019, using a cone/plate system (CP50-2 cone) with an opening angle of 20. The instrument was calibrated using standard oil 10000 from the Physikalisch-Technisches Bundesanstalt. The measurement temperature is 25.00° C.+/−0.05° C., the measuring time 3 min. The reported viscosity represents the arithmetic mean of three individual measurements conducted independently. The measurement uncertainty of the dynamic viscosity is 1.5%. The shear rate gradient was selected as a function of the viscosity and is identified separately for each reported viscosity.

### EXAMPLES

The examples which follow serve to elucidate the invention without limiting it.

All parts and percentages data in the examples described hereinafter are by weight unless otherwise stated. The examples below, unless otherwise stated, are carried out at a pressure of the surrounding atmosphere, in other words approximately at 1000 hPa, and at room temperature, in other words at approximately 25° C., or at a temperature which comes about when the reactants are combined at room temperature without additional heating or cooling. All dynamic viscosity data hereinafter relate to a temperature of 25° C. The examples which follow elucidate the invention without having any limiting effect. Viscosity values reported refer to the dynamic viscosity η, determined by means of a rheometer unless otherwise stated at a shear rate of 1 s⁻¹ and reported in mPa·s.

Abbreviations used are as follows:

Ex. Example

No. Number

PDMS Polydimethylsiloxane

FPDMS Fluorine-containing polydimethylsiloxane

LSR Liquid Silicone Rubber

HTV High temperature vulcanizing

RTV Room temperature vulcanizing

wt % Percent by weight, w/w

η Dynamic viscosity in mPa·s

mol % Mole-percent, amount-of-substance fraction

mmol/g Millimoles of functional group per gram of compound

M Molar mass in g/mol

BM Base mixture

FS Fumed silica

M=M unit Monofunctional siloxane radical, R₃SiO_{1/2}

D=D unit Difunctional siloxane radical, R₂SiO_{2/2}

T=T unit Trifunctional siloxane radical, R₃SiO_{3/2}

Q=Q unit Tetrafunctional siloxane radical, SiO_{4/2}

where R stands for substituted or unsubstituted, saturated or unsaturated organic radicals.

The examples which follow use various polymers containing vinyl groups and fluoro groups (=component (A)) having the formula (Ia), which represents a subquantity of the above-defined formula (1):

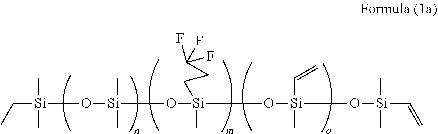

TABLE 1
Examples of polymers (A)

| | | | | | | | Si-vinyl | mol % |
|---|---|---|---|---|---|---|---|---|
| Polymer | n | m | o | n + m + o | η | M | [mmol/g] | Fluoro-D |
| A1 | 33 | 10 | 0 | 43 | 130 | 4189 | 0.477 | 22.2 |
| A2 | 85 | 23 | 0 | 108 | 310 | 10,066 | 0.199 | 20.9 |
| A3 | 120 | 30 | 0 | 150 | 500 | 13,749 | 0.145 | 19.7 |
| A4 | 240 | 75 | 0 | 315 | 3500 | 29,652 | 0.067 | 23.7 |
| A5 | 27 | 20 | 0 | 47 | 280 | 5305 | 0.377 | 40.8 |
| A6 | 58 | 40 | 0 | 98 | 500 | 10,720 | 0.187 | 40.0 |
| A7 | 91 | 55 | 0 | 146 | 1000 | 15,503 | 0.129 | 37.2 |
| A8 | 230 | 154 | 0 | 384 | 19,000 | 41,238 | 0.048 | 39.9 |
| A9 | 14 | 23 | 0 | 37 | 500 | 4811 | 0.416 | 59.0 |
| A10 | 39 | 60 | 0 | 99 | 1600 | 12,434 | 0.161 | 59.4 |
| A11 | 56 | 87 | 0 | 143 | 3500 | 17,905 | 0.112 | 60.0 |
| A12 | 120 | 185 | 0 | 305 | 70,000 | 37,932 | 0.053 | 60.3 |
| A13 | 4 | 25 | 0 | 29 | 900 | 4383 | 0.456 | 80.6 |
| A14 | 18 | 78 | 0 | 96 | 3300 | 13,688 | 0.146 | 79.6 |
| A15 | 35 | 142 | 0 | 177 | 16,200 | 24,932 | 0.080 | 79.3 |
| A16 | 50 | 215 | 0 | 265 | 110,000 | 37,431 | 0.053 | 80.5 |
| A17 | 25 | 20 | 1 | 46 | 290 | 5243 | 0.381 | 41.7 |
| A18 | 55 | 40 | 2 | 97 | 490 | 10,670 | 0.187 | 40.4 |
| A19 | 85 | 55 | 3 | 143 | 1050 | 15,317 | 0.131 | 37.9 |
| A20 | 225 | 154 | 2 | 381 | 18,900 | 41,040 | 0.049 | 40.2 |

Also used are α,ω-terminal polymers (=component (B)) of the general formula (2a), which represents a subquantity of the above-defined formula (2):

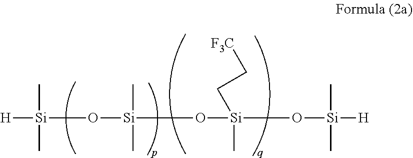

TABLE 2
Examples of polymers (B)

| | | | p + | | | Si—H | mol % |
|---|---|---|---|---|---|---|---|
| Polymer | p | q | q | η | M | [mmol/g] | Fluoro-D |
| B1 | 15 | 5 | 20 | 80 | 2024 | 0.988 | 22.7 |
| B2 | 33 | 10 | 43 | 120 | 4137 | 0.483 | 22.2 |
| B3 | 130 | 35 | 165 | 600 | 15,217 | 0.131 | 21.0 |
| B4 | 12 | 10 | 22 | 180 | 2583 | 0.774 | 41.7 |
| B5 | 27 | 20 | 47 | 300 | 5253 | 0.381 | 40.8 |
| B6 | 82 | 54 | 136 | 1080 | 14,629 | 0.137 | 39.1 |
| B7 | 6 | 12 | 18 | 280 | 2450 | 0.816 | 60.0 |
| B8 | 14 | 23 | 37 | 480 | 4759 | 0.420 | 59.0 |
| B9 | 56 | 86 | 142 | 3350 | 17,697 | 0.113 | 59.7 |
| B10 | 2 | 17 | 19 | 650 | 2934 | 0.682 | 81.0 |
| B11 | 4 | 24 | 28 | 890 | 4175 | 0.479 | 80.0 |
| B12 | 34 | 139 | 173 | 15,900 | 24,338 | 0.082 | 79.4 |

As crosslinkers, use is made of crosslinkers containing fluoro groups (=component (C)), which are reproduced by the general formula (3a), which represents a subquantity of the above-defined formula (3):

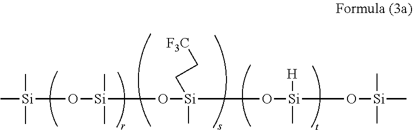

TABLE 3
Examples of crosslinkers (C)

| | | | | | | | Si—H | mol % | mmol |
|---|---|---|---|---|---|---|---|---|---|
| Polymer | r | s | t | r + s + t | η | M | [mmol/g] | Fluoro-D | Si—H/g |
| C1 | 45 | 24 | 9 | 78 | 270 | 7749 | 0.258 | 30.0 | 1.2 |
| C2 | 48 | 20 | 18 | 86 | 230 | 7887 | 0.254 | 22.7 | 2.3 |
| C3 | 25 | 11 | 36 | 72 | 200 | 5861 | 0.341 | 14.9 | 6.1 |

The polymers of the formula (3a) that are used contain the trimethylsilyl group as chain ends, with the examples not limiting the invention in this respect and with the possibility also of using other functionalities on the chain end, such as the dimethyl-Si—H radical or the dimethylvinyl radical, for example.

Component (D) used is a fumed silica prehydrophobized with trimethylsilyl groups and having a DIN EN ISO 9277 surface area of 130 m²/g.

Standard procedure for preparing the base mixture 1 (BM 1):

A compounder with a volume of 200 ml is charged with 78.0 g of α,ω-dimethylvinylsilyl-endblocked polymer (A). At room temperature over the course of 35 minutes, 78.0 g of fumed silica prehydrophobized with trimethylsilyl groups (component D)) and having a DIN EN ISO 9277 BET surface area of 130 m²/g are incorporated by kneading. This produces a composition of high viscosity which undergoes heat treatment in the compounder at 150° C. for an hour. After cooling to about 50° C. has taken place, the quantity of polymer (A) reported in table 4 is added. The dynamic viscosities η according to DIN 53019 at 25° C. and a shear rate d of 25 s⁻¹ of the respective BM 1 are reported in table 4 in mPa·s.

Standard procedure for preparing the base mixture 2 (BM 2):

A compounder with a volume of 200 ml is charged with 78.0 g of α,ω-dimethylvinylsilyl-endblocked polymer (A) (initial quantity). At room temperature over the course of 35 minutes, 78.0 g of fumed silica prehydrophobized with trimethylsilyl groups (component D)) and having a DIN EN ISO 9277 BET surface area of 130 m²/g are incorporated by kneading. This produces a composition of high viscosity which undergoes heat treatment in the compounder at 150° C. for an hour. After cooling to about 50° C. has taken place, the quantity of polymer (B) and optionally polymer (A) (added quantity) reported in table 4 is added. The dynamic viscosities η according to DIN 53019 at 25° C. and a shear rate d of 25 s⁻¹ of the respective BM 2 are reported in table 4 in mPa·s.

TABLE 4
Base mixtures BM 1 and BM 2.

| | | | Pre- | | Added | | | | |
|---|---|---|---|---|---|---|---|---|---|
| | | Initial | hydrophobic | | quantity | | η | | |
| | | quantity | FS | Added | of polymer | [%] | (d = 25) | mmol | mmol |
| BM | Polymer | [g] | [g] | polymer | [g] | filler | [mPa · s] | Si—Vi/g | Si—H/g |
| 1a | A1 | 78 | 78 | A1 | 78 | 33.3 | 4000 | 31.8 | 0 |
| 1b | A2 | 78 | 78 | A2 | 78 | 33.3 | 6500 | 13.2 | 0 |
| 1c | A3 | 78 | 78 | A3 | 78 | 33.3 | 15,000 | 9.7 | 0 |
| 1d | A4 | 78 | 78 | A4 | 78 | 33.3 | 74,500 | 4.5 | 0 |
| 1e | A5 | 78 | 78 | A5 | 78 | 33.3 | 5500 | 25.1 | 0 |
| 1f | A6 | 78 | 78 | A6 | 78 | 33.3 | 21,500 | 12.4 | 0 |
| 1g | A7 | 78 | 78 | A7 | 78 | 33.3 | 42,000 | 8.6 | 0 |
| 1h | A8 | 78 | 78 | A8 | 78 | 33.3 | 150,000 | 3.2 | 0 |
| 1i | A9 | 78 | 78 | A9 | 78 | 33.3 | 17,300 | 27.7 | 0 |
| 1j | A10 | 78 | 78 | A10 | 78 | 33.3 | 56,400 | 10.7 | 0 |
| 1k | A11 | 78 | 78 | A11 | 78 | 33.3 | 779,600 | 7.4 | 0 |
| 1l | A12 | 78 | 78 | A12 | 78 | 33.3 | 350,000 | 3.5 | 0 |
| 1m | A13 | 78 | 78 | A13 | 78 | 33.3 | 56,400 | 30.4 | 0 |
| 1n | A14 | 78 | 78 | A14 | 78 | 33.3 | 88,300 | 9.7 | 0 |
| 1o | A15 | 78 | 78 | A15 | 78 | 33.3 | 138,500 | 5.3 | 0 |
| 1p | A16 | 78 | 78 | A16 | 78 | 33.3 | 531,000 | 3.6 | 0 |
| 1q | A17 | 78 | 78 | A17 | 78 | 33.3 | 6300 | 25.4 | 0 |
| 1r | A18 | 78 | 78 | A18 | 78 | 33.3 | 14,300 | 12.5 | 0 |
| 1s | A19 | 78 | 78 | A19 | 78 | 33.3 | 38,000 | 8.7 | 0 |
| 1t | A20 | 78 | 78 | A20 | 78 | 33.3 | 148,000 | 3.2 | 0 |
| 1aa | A2 | 78 | 78 | A1 | 100 | 30.5 | 4250 | 24.7 | 0 |
| 1ab | A3 | 78 | 78 | A1 | 100 | 30.5 | 7300 | 23.1 | 0 |
| 1ac | A4 | 78 | 78 | A1 | 100 | 30.5 | 15,300 | 20.7 | 0 |
| 1ad | A6 | 78 | 78 | A5 | 100 | 30.5 | 9800 | 20.4 | 0 |
| 1ae | A7 | 78 | 78 | A5 | 100 | 30.5 | 13,000 | 18.7 | 0 |
| 1af | A8 | 78 | 78 | A5 | 100 | 30.5 | 27,500 | 16.2 | 0 |
| 1ag | A10 | 78 | 78 | A9 | 100 | 30.5 | 21,300 | 21.1 | 0 |
| 1ah | A11 | 78 | 78 | A9 | 100 | 30.5 | 35,000 | 19.6 | 0 |
| 1ai | A12 | 78 | 78 | A9 | 100 | 30.5 | 71,300 | 17.8 | 0 |
| 1aj | A14 | 78 | 78 | A13 | 100 | 30.5 | 22,300 | 22.3 | 0 |
| 1ak | A15 | 78 | 78 | A13 | 100 | 30.5 | 57,800 | 20.3 | 0 |
| 1al | A16 | 78 | 78 | A13 | 100 | 30.5 | 113,000 | 19.5 | 0 |
| 1am | A18 | 78 | 78 | A17 | 100 | 30.5 | 7900 | 20.6 | 0 |
| 1an | A19 | 78 | 78 | A17 | 100 | 30.5 | 15,000 | 18.9 | 0 |
| 1ao | A20 | 78 | 78 | A17 | 100 | 30.5 | 38,000 | 16.4 | 0 |
| 1ap | A1 | 50 | 50 | A1 | 100 | 25.0 | 2800 | 35.8 | 0 |
| 1ar | A2 | 50 | 50 | A2 | 100 | 25.0 | 4300 | 14.9 | 0 |
| 1aq | A3 | 50 | 50 | A3 | 100 | 25.0 | 11,300 | 10.9 | 0 |
| 1ar | A4 | 50 | 50 | A4 | 100 | 25.0 | 48,500 | 5.1 | 0 |
| 1as | A5 | 50 | 50 | A5 | 100 | 25.0 | 3850 | 28.3 | 0 |
| 1at | A6 | 50 | 50 | A6 | 100 | 25.0 | 13,400 | 14.0 | 0 |
| 1au | A7 | 50 | 50 | A7 | 100 | 25.0 | 23,800 | 9.7 | 0 |
| 1av | A8 | 50 | 50 | A8 | 100 | 25.0 | 91,000 | 3.6 | 0 |
| 1aw | A9 | 50 | 50 | A9 | 100 | 25.0 | 13,800 | 31.2 | 0 |
| 1ax | A10 | 50 | 50 | A10 | 100 | 25.0 | 33,000 | 12.1 | 0 |
| 1ay | A11 | 50 | 50 | A11 | 100 | 25.0 | 52,800 | 8.4 | 0 |
| 1az | A12 | 50 | 50 | A12 | 100 | 25.0 | 195,000 | 4.0 | 0 |
| 2a | A1 | 78 | 78 | B2 | 78 | 33.3 | 2500 | 15.9 | 33.9 |
| 2b | A2 | 78 | 78 | B2 | 78 | 33.3 | 3800 | 6.6 | 33.9 |
| 2c | A3 | 78 | 78 | B2 | 78 | 33.3 | 8300 | 4.8 | 33.9 |
| 2a | A4 | 78 | 78 | B2 | 78 | 33.3 | 35,000 | 2.2 | 33.9 |
| 2d | A5 | 78 | 78 | B5 | 78 | 33.3 | 2800 | 12.6 | 26.7 |
| 2e | A6 | 78 | 78 | B5 | 78 | 33.3 | 13,000 | 6.2 | 26.7 |
| 2f | A7 | 78 | 78 | B5 | 78 | 33.3 | 29,500 | 4.3 | 26.7 |
| 2g | A8 | 78 | 78 | B5 | 78 | 33.3 | 75,900 | 1.6 | 26.7 |
| 2h | A9 | 78 | 78 | B8 | 78 | 33.3 | 9800 | 13.9 | 29.4 |
| 2i | A10 | 78 | 78 | B8 | 78 | 33.3 | 23,000 | 5.4 | 29.4 |
| 2j | A11 | 78 | 78 | B8 | 78 | 33.3 | 38,500 | 3.7 | 29.4 |
| 2k | A12 | 78 | 78 | B8 | 78 | 33.3 | 131,000 | 1.8 | 29.4 |
| 2l | A13 | 78 | 78 | B11 | 78 | 33.3 | 23,200 | 15.2 | 33.6 |
| 2m | A14 | 78 | 78 | B11 | 78 | 33.3 | 41,800 | 4.9 | 33.6 |
| 2n | A15 | 78 | 78 | B11 | 78 | 33.3 | 138,500 | 2.7 | 33.6 |
| 2o | A16 | 78 | 78 | B11 | 78 | 33.3 | 231,500 | 1.8 | 33.6 |
| 2p | A17 | 78 | 78 | B5 | 78 | 33.3 | 3100 | 12.7 | 33.9 |
| 2q | A18 | 78 | 78 | B5 | 78 | 33.3 | 6900 | 6.2 | 33.9 |
| 2r | A19 | 78 | 78 | B5 | 78 | 33.3 | 15,800 | 4.4 | 33.9 |
| 2s | A20 | 78 | 78 | B5 | 78 | 33.3 | 69,300 | 1.6 | 33.9 |

In the following examples, two-component crosslinkable silicones are formulated. The proviso for compositions of the invention is the presence of an α,ω-Si—H-functional polymer (B), which may optionally carry other functionalities. Serving as comparative example are compositions wherein there is no possibility of chain extension by virtue of the presence of this polymer (B).

Production of the two-component, addition-crosslinking compositions, component I:

To produce component I, 100 g of the base mixture 1 are admixed with 0.08 g of 1-ethynylcyclohexanol (=inhibitor, component (F)) and 10 ppm of a platinum-divinyldisiloxane complex (=Karstedt catalyst, 10 ppm based on the metal Pt, component (E)) and optionally further components such as polymers, basic compositions or adjuvants and the mixture is stirred with a paddle stirrer for 10 minutes at a speed of 200 rpm at room temperature. In the following examples, the (A) component comprises not only the hydrosilylation catalyst (E) but also, optionally, an inhibitor (F), without these being recited again.

To produce component II, 100 g of the base mixture 2 are admixed with a quantity of polymer (A) and also, optionally, further additions and the mixture is stirred with a paddle stirrer for 10 minutes at a speed of 200 rpm at room temperature.

In the examples, the density is determined according to ISO 2811, the Shore A hardness according to ISO 868, the elongation at break according to ISO 37, the tensile strength according to ISO 37, and the tear resistance according to ASTM D 624 B.

### Example 1

I-Component

80 g base mixture 1a

20 g polymer A3

r (mPa·s)=3500

II-Component

10 g base mixture 1a

80 g base mixture 2a

3 g polymer A3

20 g crosslinker C3

η (mPa·s)=3300

After mixing (1:1) and crosslinking (10 min at 165° C. with pressing) the silicone rubber has the following parameters:

Hardness [Shore A]: 35

Tensile strength [N/mm²]: 2.5

Elongation at break [%]: 280

Tear resistance [N/mm]: 3.1

Elec. permittivity (50 Hz): 5.2

### Example 2

I-Component

80 g base mixture 1c

20 g polymer A3

r (mPa·s)=5000

II-Component

10 g base mixture id

80 g base mixture 2c

3 g polymer A3

8 g crosslinker C3

η (mPa·s)=4500

After mixing (1:1) and crosslinking (10 min at 165° C. with pressing) the silicone rubber has the following parameters:

Hardness [Shore A]: 28

Tensile strength [N/mm²]: 2.3

Elongation at break [%]: 360

Tear resistance [N/mm]: 3.3

Elec. permittivity (50 Hz): 5.2

### Example 3 (Comparative Example)

I-Component

80 g base mixture 1a

20 g polymer A3

η (mPa·s)=3500

II-Component

90 g base mixture 1a

3 g polymer A3

11 g crosslinker C3

η (mPa·s)=3300

After mixing (1:1) and crosslinking (10 min at 165° C. with pressing) the silicone rubber has the following parameters:

Hardness [Shore A]: 30

Tensile strength [N/mm²]: 0.8

Elongation at break [%]: 120

Tear resistance [N/mm]: 0.9

Elec. permittivity (50 Hz): 5.2

### Example 4

I-Component

80 g base mixture 1ae

20 g polymer A7

η (mPa·s)=8000

II-Component

10 g base mixture 1ae

80 g base mixture 2f

3 g polymer A7

25 g crosslinker C2

η (mPa·s)=2000

After mixing (1:1) and crosslinking (10 min at 165° C. with pressing) the silicone rubber has the following parameters:

Hardness [Shore A]: 24

Tensile strength [N/mm²]: 4.0

Elongation at break [%]: 320

Tear resistance [N/mm]: 3.5

Elec. permittivity (50 Hz): 5.8

### Example 5 (Comparative Example)

I-Component

80 g base mixture 1ae

20 g polymer A7

η (mPa·s)=8000

II-Component

60 g base mixture 1a

3 g polymer A3

35 g crosslinker C3

η (mPa·s)=1800

After mixing (1:1) and crosslinking (10 min at 165° C. with pressing) the silicone rubber has the following parameters:

Hardness [Shore A]: 22

Tensile strength [N/mm²]: 1.0

Elongation at break [%]: 110

Tear resistance [N/mm]: 1.3

Elec. permittivity (50 Hz): 5.8

1.-7. (canceled)

8. A silicone composition, comprising:
(A) 20-70 wt % of at least one polyorganosiloxane having a dynamic viscosity of 50-100,000 mPa·s at 25° C. and at a shear rate d=1 s⁻¹, having at least two radicals per molecule with aliphatic carbon-carbon multiple bonds, and comprising at least 5 mol % of 3,3,3-trifluoropropylmethylsiloxy units or at least 5 mol % of bis(3,3,3-trifluoropropyl)siloxy units, or at least 5 mol % of a mixture of both 3,3,3-trifluoropropylmethylsiloxy units and bis (3,3,3-trifluoropropylsiloxy units;
(B) 10-70 wt % of at least one linear α,ω-Si—H functional polyorganosiloxane having a dynamic viscosity of 50-100,000 mPa·s at 25° C. and at a shear rate d=1 s⁻¹, and comprising at least 5 mol % of 3,3,3-trifluoropropylmethylsiloxy units or at least 5 mol % of bis(3,3,3-trifluoropropyl)siloxy units or at least 5 mol % of a mixture of both 3,3,3-trifluoropropylmethylsiloxy units and bis (3,3,3-trifluoropropylsiloxy units;
(C) 0.1-50 wt % of at least one organosilicon compound containing at least 3 hydrogen atoms bonded to silicon per molecule, and further comprising at least 2.5 mol % of 3,3,3-trifluoropropylmethylsiloxy or at least 2.5 mol % of bis(3,3,3-trifluoropropyl)siloxy units or at least 2.5 mol % of a mixture of both 3,3,3-trifluoropropylmethylsiloxy units and bis (3,3,3-trifluoropropylsiloxy units;
(D) 1-40 wt % of reinforcing, surface-treated filler having a specific BET surface area of at least 50 m²/g, where the surface treatment is a hydrophobization and gives the filler (D) a carbon content of at least 0.01 up to a maximum of 20 wt %; and
(E) at least one hydrosilylation catalyst,
the amounts of (A) through (E) selected so that they total to 100 wt %, the composition optionally containing one or more solvents.

9. A silicone film having a film thickness of 0.1 to 500 μm prepared from a silicone composition of claim 8.

10. A continuous process for producing thin silicone films having a film thickness of 0.1 to 500 μm and a thickness accuracy of ±5% measured over an area of 200 cm², comprising:
i) applying a solvent-containing or solvent-free silicone composition of claim 8, a slot of a slot die onto a moving support,
ii) subsequently, removing the solvent, if present, from the silicone layer which forms on the support film, and crosslinking the silicone layer,
iii) optionally separating the resulting silicone film from the support after crosslinking,
with the following provisos:
the slot die in step i.) is at an angle of between 10° and 90° to the support;
the running speed of the support is between 0.1 and 500 m/in;
the dynamic viscosity of the silicone composition as measured according to DIN53019 (at 25° C. and a shear rate of 1 s⁻¹ is between 100 mPa·s and 1000 Pa·s.

11. A multi-ply assembly, comprising at least one ply of a silicone film of claim 9.

12. A multi-ply assembly, comprising at least one ply of a silicone film prepared by the process of claim 10.

13. In an electrical actuator, sensor or generator employing a polymer film, the improvement comprising employing a film of claim 9.

14. In an electrical actuator, sensor or generator employing a polymer film, the improvement comprising employing a film prepared by the process of claim 10.

15. A media-resistant component, comprising a crosslinked composition of claim 8.

16. In a shaped article prepared by 3D printing by a generative drop-on-demand (DOD) process, wherein a crosslinkable polymer is employed, the improvement comprising employing a silicone composition of claim 8.
